(19) United States
(12) Patent Application Publication
(10) Pub. No.: US 2024/0383774 A1
(43) Pub. Date: Nov. 21, 2024

(54) SUPPLY SYSTEM FOR GENERATING CHLORINE DIOXIDE AND FOR MIXING IT INTO WATER, AND METHOD FOR MONITORING AND CONTROLLING SUCH A SUPPLY SYSTEM

(71) Applicant: Krones AG, Neutraubling (DE)

(72) Inventors: Andreas MEYER, Parkstetten (DE); Markus STUBENHOFER, Regensburg (DE)

(21) Appl. No.: 18/665,366

(22) Filed: May 15, 2024

(30) Foreign Application Priority Data
May 19, 2023 (DE) 102023113160.5

(51) Int. Cl. C02F 1/00; B67C 3/22; C01B 11/02; C02F 1/50

(52) U.S. Cl. CPC C02F 1/008; B67C 3/22; C01B 11/024; C02F 1/50; B67C 2003/228; C02F 2209/006; C02F 2303/04

(57) ABSTRACT

The disclosure relates to a supply system for generating chlorine dioxide and for mixing it into water in a filling system or a similar system for food production, and to a method for monitoring and controlling the supply system. This comprises sensors for monitoring at least one consumable material parameter and at least one machine parameter relating to the feed and/or concentration of the chlorine dioxide into/in the water, a data output for transmitting measurement data from the supply system obtained by means of such sensor-based monitoring, and a data input for receiving external control data for controlling the supply system. By means of the measurement data and the received control data, the supply system can be controlled in a programmed manner, and enables remote-controlled optimization of processes for producing, distributing, and using chlorine dioxide in a filling system.

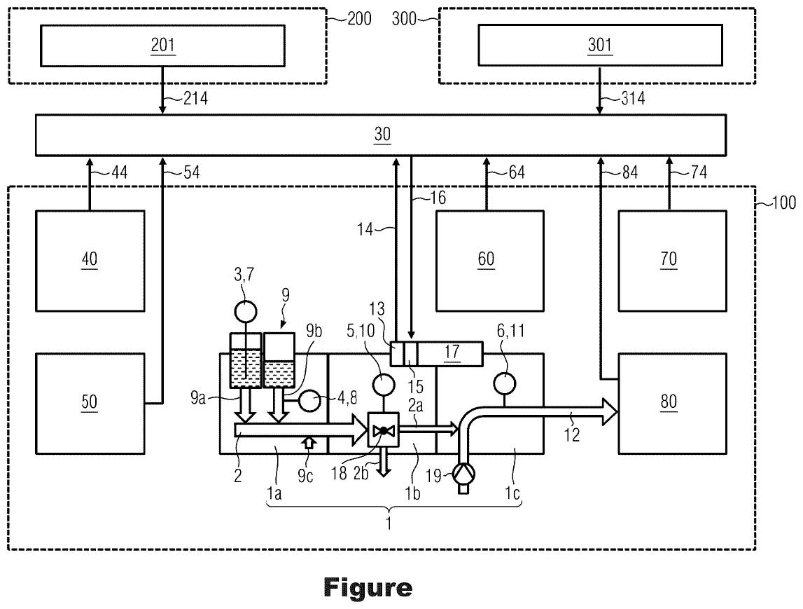

### CROSS REFERENCE TO RELATED APPLICATION

The present application claims priority to German Patent Application No. 10 2023 113 160.5 filed on May 19, 2023. The entire contents of the above-listed application are hereby incorporated by reference for all purposes.

### TECHNICAL FIELD

The disclosure relates to a supply system for generating chlorine dioxide and mixing it into water in a filling system or similar system for food production, and to a method for monitoring and controlling such a supply system.

### BACKGROUND

Supply systems for generating chlorine dioxide and mixing it into process water can be used, as is known, in systems for filling liquid products, such as beverages, into containers, such as bottles, for example. Chlorine dioxide has proven to be a particularly effective biocide for disinfecting different process units of filling systems, with simultaneously low corrosivity and reaction into non-critical decomposition products. This is especially the case if the chlorine dioxide is produced from an alkaline starting component and an acidic starting component based upon sulfuric acid, or produced in a combination of alkaline and neutral starting components. However, due to low shelf life, the chlorine dioxide must be produced on-site in the filling system.

### SUMMARY

It is known in principle to monitor machine parameters of such supply systems with respect to the feed and/or concentration of the chlorine dioxide into and/or in the process water. The same applies to parameters of consumable materials of such supply systems, which can be, on the one hand, the starting components for producing the chlorine dioxide and, on the other, technical additives, wherein, for example, their fill levels, consumption, and/or certain properties, such as pH values or concentrations, can be continuously monitored. Measurements of such machine parameters and consumable material parameters then generally furnish actual values which can be used—for example, by making a comparison with setpoint values—for controlling or regulating such supply systems.

However, it is disadvantageous that the associated optimization and planning requires a great deal of experience with the given supply system and/or with the system comprising it, and also personnel with corresponding qualifications.

There is therefore a need for improvement—for example, in order to optimize chlorine dioxide supply systems after installation, maintenance, or product changeover more quickly and/or with regard to more efficient provision of associated consumable materials.

The stated object is achieved with a supply system and with a method for monitoring and controlling the supply system, and with a filling system comprising the supply system, as described herein.

The supply system accordingly serves to generate chlorine dioxide, and to mix it into water of a filling system. The supply system comprises for this purpose: sensors for monitoring at least one consumable material parameter in the form of an inflow, consumption, supply, and/or a property of at least one starting component for the local production of the chlorine dioxide and for monitoring at least one machine parameter relating to the feed and/or concentration of the chlorine dioxide to and/or in the water; at least one data output for transmitting measurement data from the supply system, obtained by means of such sensor-based monitoring; at least one data input for receiving external control data for controlling the supply system; and a programmable logic control device for controlling the supply system on the basis of the received control data and measurement data obtained by means of the sensor-based monitoring.

The measurement data obtained can thus be collected and processed outside the supply system—for example, in a cross-machine monitoring system. The external control data can also be generated there and transmitted to the supply system.

A central processing of the measurement data and generation of the control data is thus possible externally—for example, in order to offset the measurement data obtained with the sensors against one another and/or against historical measurement data. This makes it possible, for example, to predict how certain configurations of machine parameters and consumable material parameters can affect future production processes. Historical measurement data or other empirical values of supply systems of comparable design can also be incorporated into the central and/or external data processing.

On this basis, the control data can be generated automatically and sent to the supply system in order, for example, to adapt a specific machine state and/or an operating mode of the supply system in a suitable manner. For example, at least one actuator, e.g., a pump or a valve, of the supply system can accordingly be activated directly, or an associated setpoint value can be adjusted. This can relate to the at least one monitored consumable material parameter and/or machine parameter.

By definition, “monitoring” is to be understood here as meaning a continuous measurement repeated at sufficiently short time intervals such that a time profile of the monitored parameter within a running production or maintenance process can be determined or predicted for planning such a process.

The “water” can be process water of the filling system, waste water of the filling system, or drinking water obtained from such process water and/or waste water. Process and/or waste waters are generally to be understood here as water-based solutions, and are not limited to certain ingredients.

Consumable materials in the sense of the present disclosure are in particular those for which batch-wise replenishment of transport containers or the like is required—for example, the aforementioned starting components for producing the chlorine dioxide, technical additives such as anti-corrosion agents, and also cleaning agents, acids and alkalis for pH regulation, and lubricants for drives. In contrast to this, there is also the consumption from (public) energy supply networks. In the sense of the present disclosure, electricity, gas, and fresh water consumption can therefore be regarded as machine parameters of the supply system, and can be monitored accordingly.

The described central evaluation of the collected measurement data for generating the control data is carried out in a cross-machine monitoring system for digital location-independent monitoring of machine states (a condition monitoring tool, also called a watchdog), which can be provided in a data cloud or on associated servers in a manner known in principle. In this case, “cross-machine” can also be understood to mean, in particular, “cross-system,” i.e., for example, at least two production locations.

With a cross-machine monitoring system, a display of measurement data, machine states, and/or action recommendations is also possible on mobile terminals—for example, on a smartphone or a smartwatch. Prognosis data can also be determined and output in this way—for example, the remaining running time of the supply system that is possible with given quantities of consumable material. Instructions for the replenishment of certain consumable materials can also be output in a mobile manner. Such information can, for example, also be sent directly to the supply system and displayed there, along with the control data.

In a filling system comprising the supply system, further measurement data and/or machine state data can also be determined and transmitted to the cross-machine monitoring system—in particular, to process units which are supplied with the water to which the chlorine dioxide produced has been added. The process units can, for example, be a tunnel pasteurizer, a cooling tower, a bottle washing machine, and/or a treatment unit for disposal and in particular treatment of the water to which the chlorine dioxide is added.

On the one hand, the operation of the supply system can thus be adapted quickly to the measurement data and/or machine state data ascertained in this way. On the other hand, such measurement data and/or machine state data can also be stored by the cross-machine monitoring system for later data evaluations, and used for statistical evaluations or the like, for example. The production operation of the supply system can thus be effectively optimized, both with regard to the current production operation in the filling system and with regard to different empirical values, with the supply system, the same supply systems, and/or further production processes with the supply system.

The supply system comprises at least one generating unit for generating chlorine dioxide at least from an alkaline starting component, which in particular is based upon sodium chlorite or consists thereof, and an acidic or neutral starting component, and optionally also a distribution unit for distributing the chlorine dioxide produced therefrom to at least two water circuits which are separated from one another. A plurality of process units of the filling system can thus be efficiently supplied with correspondingly disinfected water. The acidic starting component is based upon or consists of, for example, sulfuric acid or hydrochloric acid. Sulfuric acid, on the one hand, enables lower chloride concentrations than hydrochloric acid, which, on the other, has the advantage of drinking water approval. The neutral component is based upon or consists of, for example, peroxodisulfate.

In the method for monitoring and controlling a supply system of the type described, actual values of at least one consumable material parameter relating to a starting component for producing the chlorine dioxide, and also at least one machine parameter relating to the feed and/or concentration of the chlorine dioxide to or in the water, are monitored by means of sensors. Furthermore, measurement data obtained on this basis are sent into a region outside the supply system and, in particular, outside the filling system, and control data provided from outside for controlling the supply system are accordingly received in the opposite direction. Finally, the supply system is controlled in an electronically programmed manner on the basis of the received control data and measurement data obtained by means of the sensor-based monitoring.

The supply system, and in particular the overall system resulting from the supply system and the cross-machine monitoring system, thus enables fully automated chlorine dioxide generation and provision for process units in food-producing production systems—for example, in a filling system, a brewery, or the like. The same applies to the method described, which is optionally designed for fully automated and/or digitized monitoring and control of such a supply system.

The chlorine dioxide production may be based upon the so-called peroxodisulfate process, and/or, with comparatively lower priority, on the so-called sulfuric acid process or the hydrochloric acid process.

With the described method and supply system and/or overall system, not only the generation of the chlorine dioxide per se can be monitored; rather, the supply system and/or overall system can react by means of a feedback control to anomalies or similar production conditions in the individual chlorine dioxide consumers, e.g., in a washing machine, a pasteurizer, in drinking water treatment, waste water treatment, and/or disinfection, and can independently carry out adaptations to the generation of chlorine dioxide. This may be cloud- and/or AI-based.

Examples of the aforementioned anomalies/production circumstances are:
increased product entry (sugar, proteins) into the water (process water) by the bursting of containers in a pasteurizer;
preliminary increase of the chlorine dioxide concentration in the water (process water) in order to avoid nucleation; the requirements for the quality of the chlorine dioxide are relatively low for this purpose, so that its production can be optimized to a high yield (for example, by adapting the mixing ratio of the starting materials);
changeover of the filled product—for example, from water to carbonated soft drinks;
increased demand for chlorine dioxide for disinfection, due to increased sugar content and/or protein content, which increases the risk of undesirable microbiological growth; the supply system then increases the chlorine dioxide concentration and automatically stores more chlorine dioxide in order to be able to catch up with such changes (optimization of storage, since chlorine dioxide is unstable and cannot always be stored as long as desired);
particularly heavily contaminated bottles, in the case of reusable containers in bottle washing machines; there is an increased demand for chlorine dioxide for disinfection in the last cleaning step, since the microbial load was reduced to a lesser extent beforehand during the cleaning of the highly contaminated bottles than in the case of normally contaminated containers; the supply system and/or overall system then automatically increases the chlorine dioxide concentration and automatically stores more chlorine dioxide when such bottles are already detected before the cleaning in the bottle washing machine;
chlorine dioxide can be used for waste water treatment up to drinking water quality; in order to comply with the limit values according to a drinking water ordinance, such as, for example, chlorate concentrations, the chlorine dioxide quality required for this can be controlled by its production, and thus by the supply system and/or overall system. This is possible across production lines—for example, by preparing/disinfecting dirty water to produce drinking water and using it as a starting material for beer brewing.

For an automatic control process that is intelligent and, if necessary, works across multiple production lines, production plans can on the one hand be used, e.g., by virtue of artificial intelligence (AI: for example, implemented by means of algorithms known in principle in the cross-machine monitoring system) implemented in the control system automatically detecting the need for action on the basis of the filled products—for example, due to anomalies to be expected. On the other hand, in the event of an anomaly occurring, chlorine dioxide which is planned at another point can optionally be diverted briefly in order to prevent a production halt or negative influence on the overall output of the production due to the anomaly. Such an anomaly would, for example, be an increased microbiological load and/or organic contamination on the bottles as a result of beer foaming over during filling. While a production halt of filling machines with regard to the overall output should be avoided as a matter of course, certain cleaning programs, such as for disinfecting transport units or for washing bottle cases, are less time-critical and can optionally be postponed. For this purpose, the quantity of chlorine dioxide planned and already produced can then, in particular, be automatically diverted and used quickly for disinfection of the filling machine by means of AI. In parallel, more chlorine dioxide can be generated in order to catch up with the cleaning and/or disinfection programs which have been moved forward.

The described overall system (with the cross-machine monitoring system integrated into the control process) in principle monitors functions and requirements of a plurality of process units involved in the production, and regulates the production and provision of the chlorine dioxide for individual process units during ongoing production operation—for example, in response to existing or imminent anomalies and/or on the basis of known production data. As a result, chlorine dioxide can be made available automatically in the required quantities with the required quality.

In principle, it is also conceivable to optimize the production of individual batches according to corresponding prioritization of the quality vs. the yield—for example, taking into account both production-specific and economic parameters. A combination of different production methods for chlorine dioxide (see above) would also be possible, since these differ considerably in terms of costs and quality of the generation of chlorine dioxide. Depending upon the type and size of the supplied production line/production plant, producers working on the peroxodisulfate, sulfuric acid, and/or hydrochloric acid processes can be contemplated.

### BRIEF DESCRIPTION OF THE FIGURE

An embodiment of the disclosure is illustrated in the drawing. The single FIGURE schematically shows a supply system for generating chlorine dioxide and for mixing (metering) it into water, e.g., process water, as a component of a filling system, and with a cross-machine monitoring system.

### DETAILED DESCRIPTION

As can be seen from the FIGURE, the supply system 1 is operated in a filling system 100 and can be functionally subdivided into a generating unit 1a for generating chlorine dioxide 2, an optional distribution unit 1b for distributing the chlorine dioxide 2, and at least one feed unit 1c for feeding the chlorine dioxide 2 to the water 12.

In the optional distribution unit 1b, the chlorine dioxide 2 produced is distributed to substreams 2a, 2b, which can be fed to the water 12 separately from one another. This serves to supply different process units of the filling system 100 with water 12 containing chlorine dioxide. The water 12 is then by definition process water (shown) of the filling system 100. Alternatively, however, the water 12 could also be waste water (not shown) of the filling system 100 or drinking water prepared from process water and/or waste water (not shown).

The metered addition of the chlorine dioxide 2, i.e., its inflow into the water 12, can be adjusted according to the line routing in each of the above-mentioned functional units. These can be combined locally in a device unit and/or distributed spatially to a plurality of device units.

The supply system 1 comprises sensors 3, 4, 5, 6 for the ongoing monitoring of at least one consumable material parameter 7, 8 of at least one consumable material 9 of the supply system 1, and for monitoring at least one machine parameter 10, 11 of the supply system 1 relating to the feed and/or concentration of the chlorine dioxide 2 into and/or in the water 12.

The at least one consumable material 9 is, in the example, an alkaline starting component 9a for producing the chlorine dioxide 2 and an acidic or neutral starting component 9b for producing the chlorine dioxide 2. The alkaline starting component 9a is, for example, sodium chlorite (NaClO₂); the acidic variant of the starting component 9b is, for example, a solution based upon sulfuric acid. However, a different acid would in principle also be conceivable—for example, citric acid or hydrochloric acid. In its neutral variant, the starting component 9b is preferably peroxodisulfate. Starting components are understood here to be indispensable components for the production of chlorine dioxide 2, in contrast to optional components, such as an additive 9c, which support a certain technical effect of chlorine dioxide 2 and/or can improve its shelf life.

In the example shown, a first sensor 3 measures a first consumable material parameter 7, which here is a fill level of the alkaline starting component 9a. Furthermore, a second sensor 4 measures a second consumable material parameter 8, which here relates, by way of example, to an inflow of the acidic or neutral starting component 9b of the chlorine dioxide 2. It goes without saying that the alkaline and the acidic/neutral starting components 9a, 9b are preferably monitored in the same way, which is not shown in the FIGURE for the sake of clarity.

A plurality of consumable material parameters 7, 8 of the supply system 1 are preferably monitored (independently of the embodiment shown)—for example, an inflow, consumption, storage supply, and/or a specific property, such as a pH or the like, of the corresponding consumable material 9.

The monitored consumable materials 9 are (independently of the embodiment shown), in particular, those which are used for production operation and the regular maintenance of the supply system 1, and must be refilled as required, e.g., for hygienic and reliable operation of the supply system 1, for the cleaning thereof, and/or as auxiliary substances for its units or actuators, such as pumps, valves, or the like.

As examples of machine parameters in the sense of the present disclosure, a first machine parameter 10 in the form of a valve position of the distribution unit 1b is measured with a third sensor 5, and a second machine parameter 11 in the form of a concentration of the chlorine dioxide 2 in the water 12 is measured with a fourth sensor 6. Other conceivable machine parameters would, for example, be the conductance, the pH, or a microbiological characteristic of the water 12 or the like.

In the production operation of the supply system 1, consumable material 9 can be automatically metered in by means of metering devices (not shown) known in principle—for example, to the chlorine dioxide 2 and/or the water 12. Likewise, for the maintenance of the supply system 1, a corresponding metered addition to a cleaning liquid and/or to rinse water (not shown) is possible.

The supply system 1 comprises at least one data output 13 for transmitting measurement data 14, which are obtained with at least one of the sensors 3-6. The measurement data 14 can be both raw data and measurement data processed in a suitable manner in the region of the supply system 1.

The transmission of the measurement data 14 is to be understood as meaning their export into a region outside the supply system 1, and in particular into a region outside the filling system 100 comprising the supply system 1.

The supply system 1 comprises at least one data input 15 for receiving external control data 16, i.e., data which are generated outside the supply system 1 and in particular outside the filling system 100 comprising said supply system, for controlling the supply system 1, and which are imported from there.

During the production operation, the measurement data 14 may be exported continuously, and the receipt of the external control data 16 is then possible continuously.

The supply system 1 comprises at least one programmable logic control device 17 for controlling the supply system 1 by means of the control data 16 received via the at least one data input 15 and by means of at least one portion of the measurement data 14 which are obtained by means of the sensors 3-6. The at least one programmable logic control device 17 may include a processor and memory for storing instructions for carrying out the operations described herein. The measurement data 14 can be processed internally by the control device 17 and/or can be transferred to it from the respective sensor or measuring device in an already suitably processed manner.

The control data 16 can, for example, be setpoint values of individual consumable material parameters 7, 8 and/or individual machine parameters 10, 11, which, for controlling the supply system 1, can be compared to actual values determined by the sensors 3-6 in a manner known in principle to generate an error signal fed to controller gains to generate control output. Additionally or alternatively, a control signal other than an error signal could be generated and fed to controller gains. However, the control data 16 can also be control signals for the direct control of actuators of the supply system 1. For example, the control data 16 can be used to control a valve 18 for flow control/distribution of the chlorine dioxide 2 in the supply system 1 and/or at least one pump 19 for conveying the water 12.

The control functions (or feedback functions) described are to be understood as examples of the control process of the supply system 1, and are based upon corresponding programming of the control device 17, which in principle has a known architecture and can comprise input and output functions for operators.

The export of the measurement data 14 and the import of the control data 16 take place here between the supply system 1 and a cross-machine monitoring system 30, which can also be referred to as a condition monitoring tool or a so-called watchdog.

The cross-machine monitoring system 30 can operate on the basis of a data cloud and can thus be provided, for example, on external servers.

The export and/or import of the measurement data 14 or of the control data 16 from/to the supply system 1 is possible, for example, wirelessly. It would also be conceivable to equip individual functional units of the supply system 1, such as the generating unit 1a, the distribution unit 1b, and the feed unit 1c, with their own data outputs 13 and data inputs 15 of the type described (not shown).

The measurement data 14 sent by the supply system 1 can be stored and evaluated in the cross-machine monitoring system 30. On the one hand, these can be associated with the supply system 1 overall, and on the other, also individual production processes of the supply system 1 (production batches). This enables statistical evaluations of the measurement data 14 even over a plurality of production processes, in the sense of a historical process/system optimization.

The cross-machine monitoring system 30 can also process measurement data of other process units of the filling system 100 and compare and/or calculate them with measurement data 14 of the supply system 1.

For example, the filling system 100 can comprise: a bottle washing machine 40 for empty bottles; a filling machine 50 for fill products; a treatment unit 60 for processing or waste water treatment of the water 12—in particular, for drinking water; a pasteurization tunnel 70 for pasteurizing the filling products; and a cooling tower 80 associated with, for example, the bottle washing machine 40 and the pasteurization tunnel 70. Water 12 mixed with chlorine dioxide 2 can then be used, for example, in the bottle washing machine 40, the pasteurization tunnel 70, and the cooling tower 80, which is indicated by way of example only for the cooling tower 80.

Such process units can in each case optionally transmit associated measurement data 44, 54, 64, 74, 84 by corresponding data export to the cross-machine monitoring system 30, wherein these can be specifically consumable material parameters and/or machine parameters of the corresponding process unit.

A cross-machine evaluation of measurement data 14, 44, 54, 64, 74, 84 in the monitoring system 30 is thus possible, and thus a correspondingly comprehensive creation and transmission of external control data 16 to the supply system 1 is possible.

The cross-machine monitoring system 30 can also work cross-system—for example, including measurement data 214, 314, which are transmitted by at least one corresponding supply system 201, 301 for producing/admixing chlorine dioxide of at least one further filling system 200, 300. Likewise, measurement data of other process units (not shown), from each of their corresponding filling systems 200, 300, could be transmitted to the cross-machine monitoring system 30.

A large quantity of measurement data of the type described can be calculated in tandem with one another and used as the basis for the output of external control data 16 for the supply system 1, as a result of a cross-system evaluation of measurement data 14, 214, 314 of the supply systems 1, 201, 301 for producing/admixing chlorine dioxide-which can be structurally identical—for example, with regard to certain specifications. Numerous empirical values can thus be used both for cross-machine process and system optimization within the filling system 100, and also cross-system, i.e., taking into account a plurality of filling systems 100, 200, 300.

With the aid of the described export of measurement data 14 and import of external control data 16, machine functions, the consumable material supply, and/or the maintenance of the supply system 1 can be automatically remote-controlled—for example, by the cross-machine monitoring system 30, i.e., by a digital path and/or by online management.

The sensors 3-6 can monitor consumable material parameters 7, 8, such as, for example, concentrations and/or fill levels of consumable materials, e.g., the starting components 9a, 9b, of additives 9c for the chlorine dioxide 2 or the water 12 or the like, and also machine parameters 10, 11, which can, for example, be a water temperature, a water quality, a water consumption, an energy consumption, a pump pressure, a filter permeability, or the like.

Likewise, ambient conditions or environmental parameters, e.g., the external air temperature and/or the external air humidity in the region of the supply system 1, and/or microbiological parameters, e.g., of the water 12, can be measured and can be incorporated as measurement data 14 into the external data evaluation and generation of control data 16.

The capture of the measurement data 14 and the transmission of the control data 16 are therefore possible fully automatically together with the associated control of the supply system 1. For example, control signals for individual actuators of the supply system 1 can be transmitted directly to them, and/or operating modes or control programs of the supply system 1 can be automatically selected by means of the control data 16.

Measurement data (not shown) obtained in the product verification, for example, can also be incorporated into the processing of the measurement data 14 and optionally 214, 314, and into the generation of the control data 16, or the like. In the case of hygienically inadequate verification outcomes, the supply system 1 can automatically react to the respective quality deviations by means of the external control data 16; for example, it can increase the concentration of the chlorine dioxide 2 in the water 12.

The cross-machine monitoring system 30 can use self-learning algorithms in order to successively optimize the treatment quality and/or efficiency of the production or maintenance on the basis of growing experience of measurement data 14 and optionally 214, 314.

On the basis of the received measurement data 14 and optionally 214, 314, the cross-machine monitoring system 30 can automatically react to specific machine states or fault states of the supply system 1 or to evaluations of the measurement data 14 generated there, and, for example, carry out a remote diagnosis and/or initiate a correction of errors remotely.

In addition, measurement data 14 from the supply system 1 can be directly processed in a manner known in principle, e.g., in the control device 17, in order to generate internal control data (not shown).

With the supply system 1 and the described method for the monitoring and control thereof, process conditions of the production, distribution, and metered addition of chlorine dioxide 2 can be successively improved by an additional evaluation of historical measurement data 14 (earlier production processes/production batches). In addition, consumable material 9 can be used more efficiently, and its replenishment can be organized automatically, reliably, and as required—for example, for the starting components 9a, 9b.

The measurement data 14 collected can in principle be used across the site as a whole, for comprehensive external data analysis and optimization of processes for producing, distributing, metering, and using chlorine dioxide 2 in filling systems 100.

In the supply system 1 described or with the method described, machine parameters 10, 11 can be monitored—for example, with regard to the function of valves and pumps, deposition formation in piping/lines, the chlorine dioxide content in water 12, the functionality of metering and measuring devices, and the like—or can optionally be optimized automatically. Possible error sources and personnel requirements can accordingly be considerably reduced for these purposes.

The use of consumable material 9—in particular, the alkaline and the acidic or neutral starting components 9a, 9b of the chlorine dioxide 2—can be optimized accordingly, as also optionally for other oxidizing biocides, such as, for example, chlorine bleach liquor or non-oxidizing biocides or organobiocides, such as isothiazolinones, which can also be used for disinfecting different process units of filling systems 100 or of the water 12 used there. Likewise, cleaning agents, technical additives 9c, such as, for example, means for corrosion protection, for suppressing flocking, or for hardness stabilization, and/or further acids and alkalis for pH regulation or the like can be used more efficiently. The consumption of lubricants for actuators which may be used in the supply system 1 can also be minimized.

The described sensors 3-6 can, for example, be used to monitor the fill level, consumption, and/or a property such as the concentration of certain consumable materials 9—for example, the starting components 9a, 9b, and/or additives 9c. Likewise, for example, a water quality, such as pH, visual cleanliness, turbidity, microbiological load, or the like of water 12 or other process media can be continuously monitored. Tests of the material compatibility are also possible—for example, the corrosiveness of certain consumable materials 9 in/on lines, actuators, and/or actuating members of the supply system 1.

On the basis of the measurement data 14 and optionally 214, 314, maintenance processes of other process units can also be automatically requested or initiated—for example, a heat sterilization of the pasteurization tunnel 70.

The type, number, and arrangement of the sensors 3-6 shown and the actuators controlled by means of the control data 16—such as the valve 18 and the pump 19—are merely exemplary in nature, and representative of other sensors, actuators, and assemblies of supply systems 1 of the type described, which are known in principle. This applies as well for the consumable material parameters 7, 8 and machine parameters 10, 11.

1. Supply system for generating chlorine dioxide and for mixing it into water in a system for food production comprising:
sensors for monitoring at least one consumable material parameter in the form of an inflow, consumption, storage supply, and/or a property of at least one starting component for locally producing the chlorine dioxide, and for monitoring at least one machine parameter relating to the feed and/or concentration of the chlorine dioxide into/in the water;
at least one data output for transmitting measurement data obtained from the supply system by means of such sensor-based monitoring;
at least one data input for receiving external control data for controlling the supply system; and
a programmable logic control device for controlling the supply system on the basis of the received control data and measurement data obtained by means of the sensor-based monitoring.

2. Supply system according to claim 1, having a generating unit for generating chlorine dioxide at least from an alkaline starting component, which is based upon sodium chlorite, and an acidic or substantially neutral starting component, and having a distribution unit for distributing the chlorine dioxide produced therefrom into substreams for separately mixing the chlorine dioxide into water.

3. Supply system according to claim 1, wherein the sensors are designed to measure actual values of at least two of the following consumable material parameters or machine parameters: fill level, consumption/metering capacity, or concentration of an alkaline starting component for the chlorine dioxide production; fill level, consumption/metering capacity, or concentration of an acidic or substantially neutral starting component for the chlorine dioxide production; fill level, consumption/metering capacity, or concentration of an additive in the form of an agent for preventing precipitation, for hardness stabilization, and/or for corrosion protection, conductance, turbidity, or microbial load of the water; valve position, flow rate through, or deposition thickness in a line for the chlorine dioxide or the water; output of a pump for conveying the chlorine dioxide or the water.

4. Supply system according to claim 1, wherein the control device is programmed to automatically adapt a machine state and/or operating mode of the supply system-on the basis of the received control data.

5. Supply system according to claim 1, wherein the data input is designed to receive the control data from a cross-machine monitoring system, and the data output is designed to transmit the measurement data to it.

6. Supply system according to claim 5, wherein the cross-machine monitoring system and/or the supply system is designed to generate the control data on the basis of measurement data and/or machine state data of at least one process unit supplied with the chlorine dioxide.

7. Supply system according to claim 5, wherein the cross-machine monitoring system and/or the supply system is designed to quantitatively and/or temporally control the supply of at least one process unit with the generated chlorine dioxide.

8. System for food production comprising the supply system according to claim 5 and at least one of the following process units, each configured to transmit measurement data and/or machine state data to the cross-machine monitoring system, and each supplied with the water to which chlorine dioxide is added: a pasteurization tunnel; a cooling tower; a bottle washing machine; a filling machine; and a treatment unit for treating the water.

9. Method for monitoring and controlling a supply system, for generating chlorine dioxide and mixing it into water, of a filling system, comprising: monitoring actual values of at least one consumable material parameter relating to a starting component for producing the chlorine dioxide, and at least one machine parameter relating to the feed and/or concentration of the chlorine dioxide into/in the water; transmitting measurement data obtained on this basis into a region outside the supply system; receiving control data, provided externally in response, for controlling the generation and admixture of the chlorine dioxide; and controlling, with electronic programming, the generation and admixture on the basis of the received control data and the measurement data obtained by means of sensor-based monitoring.

10. Method according to claim 9, wherein the consumable material parameters and/or machine parameters comprise: fill level, consumption/metering capacity, or concentration of an alkaline starting component for the production of chlorine dioxide; fill level, consumption/metering capacity, or concentration of an acidic or substantially neutral starting component for the production of chlorine dioxide; fill level, consumption/metering capacity, or concentration of an additive in the form of an agent for preventing precipitation, for hardness stabilization, and/or for corrosion protection, conductance, turbidity, or microbial load of the water; valve position, flow rate through, or deposition thickness in a line for the chlorine dioxide or the water; output of a pump for conveying the chlorine dioxide or the water.

11. Method according to claim 9, wherein a machine state and/or operating mode of a supply system for generating and admixing the chlorine dioxide, including the monitored consumable material parameter and/or machine parameter, is automatically adapted by means of the received control data.

12. Method according to claim 9, wherein the measurement data are sent to a cross-machine monitoring system, and the control data are received therefrom.

13. Method according to claim 12, wherein the control data are calculated by the cross-machine monitoring system on the basis of the transmitted measurement data of a production process, running in conjunction with the supply system, and corresponding measurement data of at least one historical production process with the same supply system and/or a supply system which is substantially identical in construction.

14. Method according to claim 13, wherein the control data from the cross-machine monitoring system are calculated on the basis of the transmitted measurement data and additional measurement data and/or machine state data which are sent from at least one further process unit of the filling system to the cross-machine monitoring system.

15. Method according to claim 13, wherein the cross-machine monitoring system further generates/outputs instructions for the replenishment of at least one monitored consumable material from the transmitted measurement data, and in particular transmits these instructions to the supply system.

16. Supply system according to claim 2, wherein separately mixing the chlorine dioxide into water occurs in different processing units of the filling system.

17. Supply system according to claim 4, wherein the control device is programmed to automatically adapt the machine state and operating mode of the supply system including the monitored consumable material parameter and/or machine parameter on the basis of the received control data.

18. Supply system according to claim 6, wherein the at least one process unit supplied with the chlorine dioxide is a bottle washing machine, a filling machine, a treatment unit for treating the water, a pasteurization tunnel, and/or a cooling tower.

19. Supply system according to claim 7, wherein the process unit is a bottle washing machine, a filling machine, a treatment unit for treating the water, a pasteurization tunnel, and/or a cooling tower.

20. Method according to claim 14, wherein the further process unit is supplied with the water to which chlorine dioxide has been added, and is a pasteurization tunnel, a cooling tower, a bottle washing machine, or a treatment unit for disposal and treatment of the water.
